(19) United States
(12) Patent Application Publication
(10) Pub. No.: US 2015/0103158 A1
(43) Pub. Date: Apr. 16, 2015

(54) ATTACHABLE WIRELESS MICRO-CAMERA AND SOFTWARE

(71) Applicants: Joshua Cornelius Burris, Rosenberg, TX (US); Joel Christian Burris, Rosenberg, TX (US); Jared Christopher Burris, Richmond, TX (US)

(72) Inventors: Joshua Cornelius Burris, Rosenberg, TX (US); Joel Christian Burris, Rosenberg, TX (US); Jared Christopher Burris, Richmond, TX (US)

(21) Appl. No.: 14/053,359

(22) Filed: Oct. 14, 2013

(51) Int. Cl. H04N 5/225

(52) U.S. Cl. CPC H04N 5/2253; H04N 2005/2255
USPC 348/82

(57) ABSTRACT

A wireless micro-camera is present on an expandable band that can be placed on various tools and devices to allow its user to view difficult-to-see locations on the screen of the user's smart device. The band can also include a light and charging mechanism.

### FIELD

The disclosure relates generally to image display. The disclosure relates specifically to a wireless camera that can be attached to various devices to display areas that are difficult-to-see.

### BACKGROUND

Certain locations are difficult or impossible to see while performing an action at that location. The difficulty in viewing the location can be due to it being somewhere that it is not physically possible to see without assistance, e.g., the back of your head. Although it is possible to see the back of your head while using at least two minors, it is dependent upon the orientation of the mirrors. When you are trying to perform an activity in addition to holding the mirror(s) it becomes challenging to hold all of the items. This occurs when using a razor when to shave the back of your head or a flattening iron straightening the hair on the back of your head. It is challenging to shave the back of your legs or underarms as those are not easily viewed by the ordinary person. It is also challenging to use various tools in tight locations or where it is difficult or impossible to have a line of sight view.

It would be advantageous to have a small camera that attaches to a given tool and connects with a display device wirelessly to allow a user to see an area that is difficult or impossible to view otherwise or which a user wishes to see with greater detail. A device such as this would allow a user to have his or her hands free to use the tool.

### SUMMARY

An embodiment comprises a device for visualizing an area comprising: a band capable of being placed on a non-electric tool; a wireless micro-camera located on the band; a transmitter, capable of transmitting a video signal to a display on a smart device; and a connection for receiving power located on the band. In another embodiment, the band is placed on a handle of a non-electric tool. In an embodiment, the non-electric tool is a razor. In an embodiment, the display is located on a smart device. In another embodiment, the smart device comprises an application for viewing the video signal as an image. In yet another embodiment, the band is comprised of a flexible material. In an embodiment, the transmitter is capable of transmitting over a wireless local area network. In an embodiment, the device comprises a light. In an embodiment, the device comprises a USB port. In an embodiment, the device comprises a battery.

An embodiment comprises a method of use of a visualization device comprising placing a visualization device on a non-electric tool; wherein the visualization device comprises a band capable of being located on a handle of the non-electric tool; and a wireless micro-camera located on the band; wherein the wireless micro-camera is capable of transmitting a video signal to a display; turning on the power of a smart device comprising the display; turning on the power to the visualization device; sending a video signal from the visualization device to the smart device; and displaying an image from the visualization device in a software application on the smart device as the video signal is received by the smart device. In an embodiment, a light is turned on. In an embodiment, the visualization device is charged prior to use. In an embodiment, the video signal is sent using a wireless local area network. In another embodiment, the video signal is sent using Bluetooth. In an embodiment, the display on the smart device depicts an overlay selected from the group consisting of a pattern and an outline.

An embodiment comprises a system for visualizing an area comprising a band present on a tool; a wireless micro-camera located on the band; a transmitter located on the band, wherein the transmitter is capable of transmitting a video signal to a display on a smart device; a smart device, capable of receiving a video signal from the transmitter, a display on the smart device, capable of showing the image resulting from the video signal; and a supply of power to the wireless micro-camera.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1A is a top view of the wireless micro-camera band on a razor.

FIG. 1B is a bottom view of the wireless micro-camera band on a razor.

FIG. 1C is a side view of the wireless micro-camera band on a razor.

FIG. 2A is a top view of the wireless micro-camera band on a wrench.

FIG. 2B is a bottom view of the wireless micro-camera band on a wrench.

FIG. 2C is a side view of the wireless micro-camera band on a wrench.

FIG. 3 is a view of the wireless micro-camera band.

FIG. 4 is a flow chart of the software and events for displaying the image.

FIG. 5 is a diagram of the wireless micro-camera band in use with a razor and smart device for shaving one's head.

FIG. 6 is a diagram of the wireless micro-camera band in use with a razor and smart device for trimming one's hairline.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

As used herein, the term, “smart device”, means and refers to an interactive digital device that is accessible via at least one protocol such as WiFi, Bluetooth, direct, 2G, 3G, 4G, or LTE.

As used herein, the term, “tool” means and refers to an implement for carrying out a function.

A transmitted image can be magnified. Magnification is useful for areas that are difficult-to-see and for images depicting small items. In an embodiment, a user can zoom in on an image. The image can be displayed on a smart device, smart phone, tablet, laptop, or desktop.

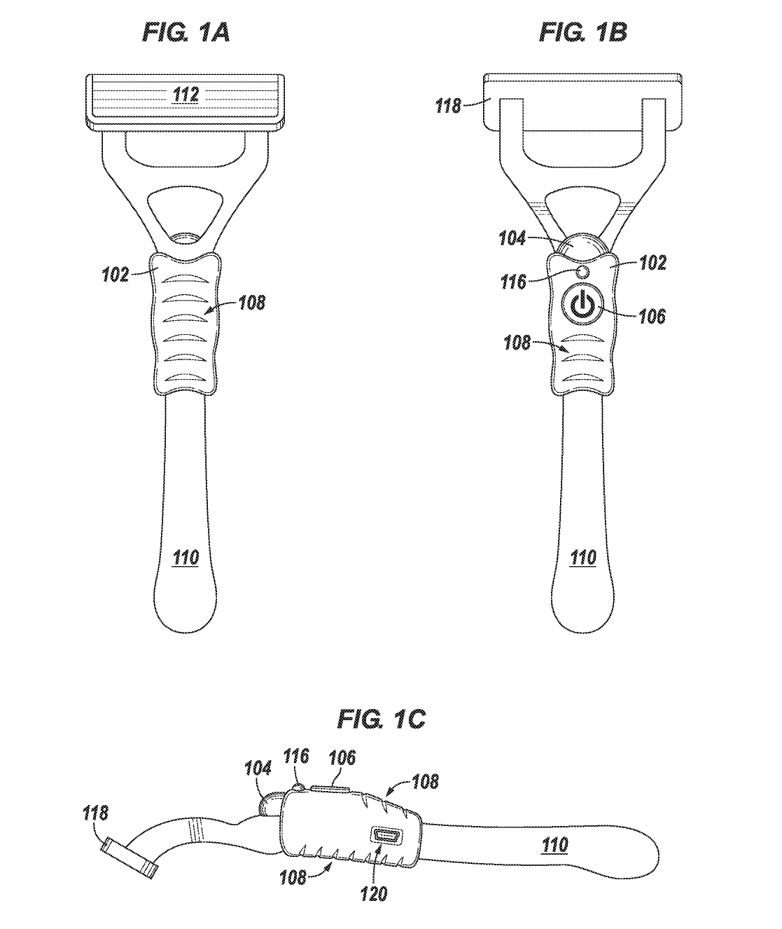

FIG. 1A depicts a top view of a wireless micro-camera band on the handle 110 of a non-electric razor. The wireless micro-camera 104 is located at one end of the band 102. The wireless micro-camera is powered on and off by pressing power switch 106. A light 116 is located behind the micro-camera 104. The micro-camera 104 obtains the image of the user's head in an approximately 160 degree angle. Therefore an image is transmitted that provides a view of the surroundings of the blade support 118 of the razor. The band 102 has ridges 108 to allow a secure grip on the device.

FIG. 1B depicts a bottom view of a wireless micro-camera band on the handle 110 of a non-electric razor. The band 102 is located proximal to the blades 112 in the cartridge 114. The band 102 has ridges 108 to allow a secure grip on the device.

FIG. 1C depicts a side view of a wireless micro-camera band on the handle 110 of a non-electric razor. The wireless micro-camera 104 is located at one end of the band 102. The wireless micro-camera 104 is powered on and off by pressing power switch 106. A light 116 is located behind the micro-camera 104. The micro-camera 104 obtains the image of the user's head in an approximately 160 degree angle. Therefore an image is transmitted that provides a view of the surroundings of the blade support 118 of the razor. The band 102 has ridges 108 to allow a secure grip on the device. A micro universal serial bus (USB) port 120 is present for charging the device.

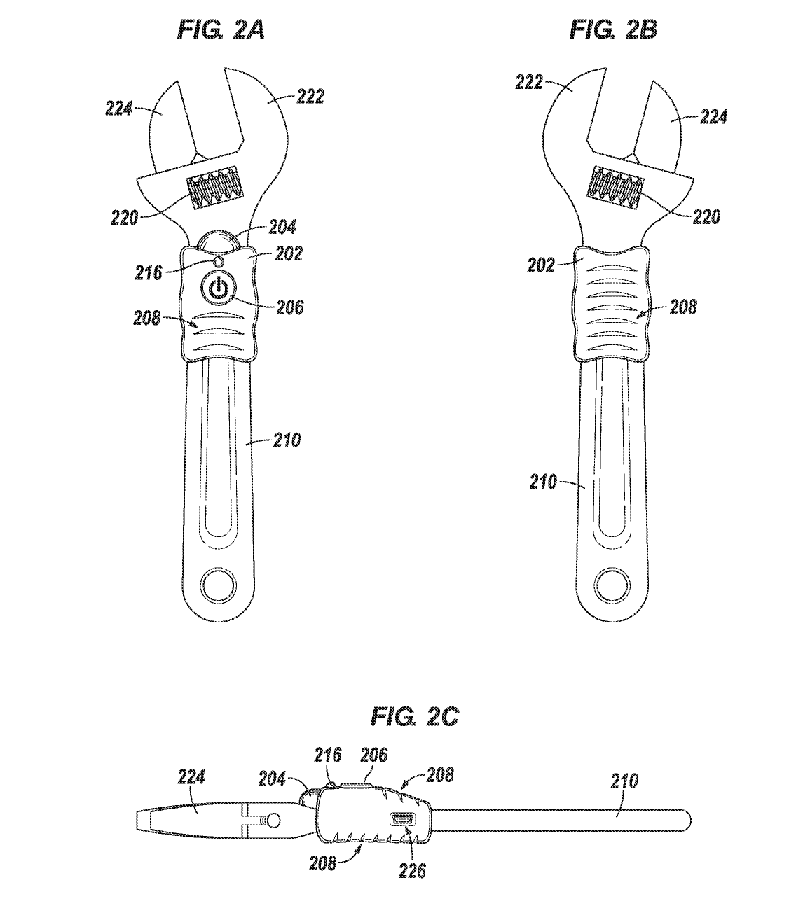

FIG. 2A depicts a top view of a wireless micro-camera band on the handle 210 of a wrench. The wireless micro-camera 204 is located at one end of the band 202. The wireless micro-camera is powered on and off by pressing power switch 206. A light 216 is located behind the micro-camera 204. The micro-camera 204 obtains the image of the area in which the wrench will be used in an approximately 160 degree angle. Therefore an image is transmitted that provides a view of the surroundings of the wrench and the jaws including a heel jaw 224. The width of the opening of the jaws is adjusted by an adjustment screw 220. The band 202 has ridges 208 to allow a secure grip on the device.

FIG. 2B depicts a bottom view of a wireless micro-camera band on the handle 210 of a wrench. The band 202 is located proximal to the jaws including a hook jaw 222 and the heel jaw 224. The width of the opening of the jaws is adjusted by an adjustment screw 220. The band 202 has ridges 208 to allow a secure grip on the device.

FIG. 2C depicts a side view of a wireless micro-camera band on the handle 210 of a wrench. The wireless micro-camera 204 is located at one end of the band 202. The wireless micro-camera 204 is powered on and off by pressing power switch 206. A light 216 is located behind the micro-camera 204. The micro-camera 204 obtains the image of the area in which the wrench will be used in an approximately 160 degree angle. Therefore an image is transmitted that provides a view of the surroundings of the wrench and the jaws including a heel jaw 224. The band 202 has ridges 208 to allow a secure grip on the device. A micro universal serial bus (USB) port 226 is present for charging the device.

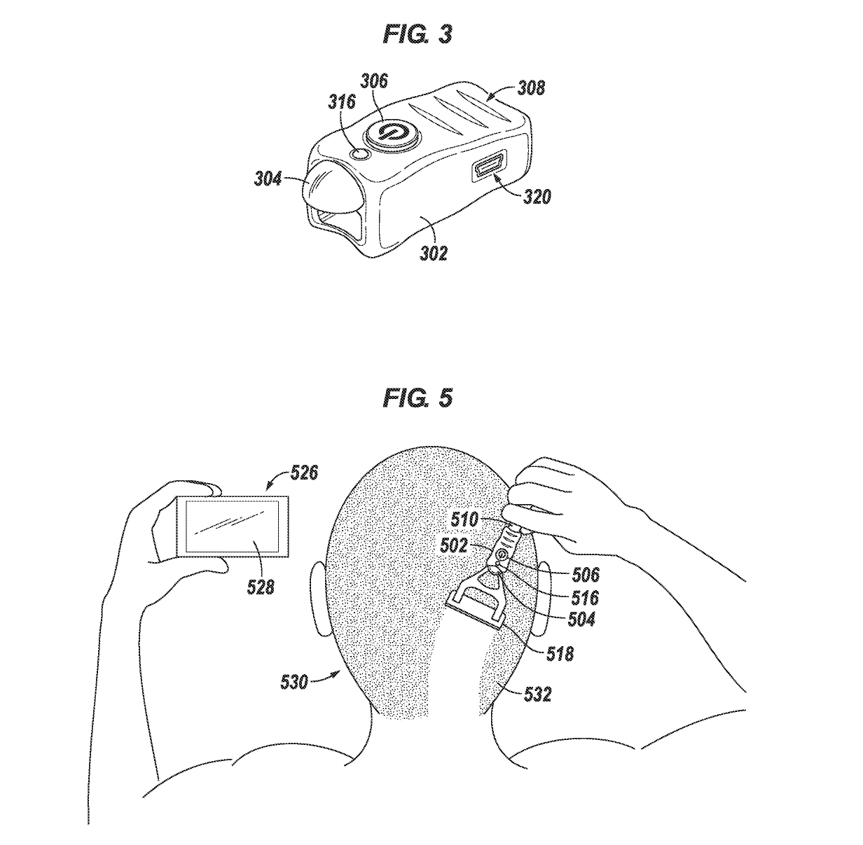

FIG. 3 depicts a wireless micro-camera band. The wireless micro-camera 304 is located at one end of the band 302. The wireless micro-camera 304 is powered on and off by pressing power switch 306. A light 316 is located behind the micro-camera 304. The micro-camera 304 obtains the image in front of it within approximately a 160 degree angle. Therefore an image is transmitted that provides a view in front of the camera. The band 302 has ridges 308 to allow a secure grip on the device. A micro universal serial bus (USB) port 320 is present for charging the device.

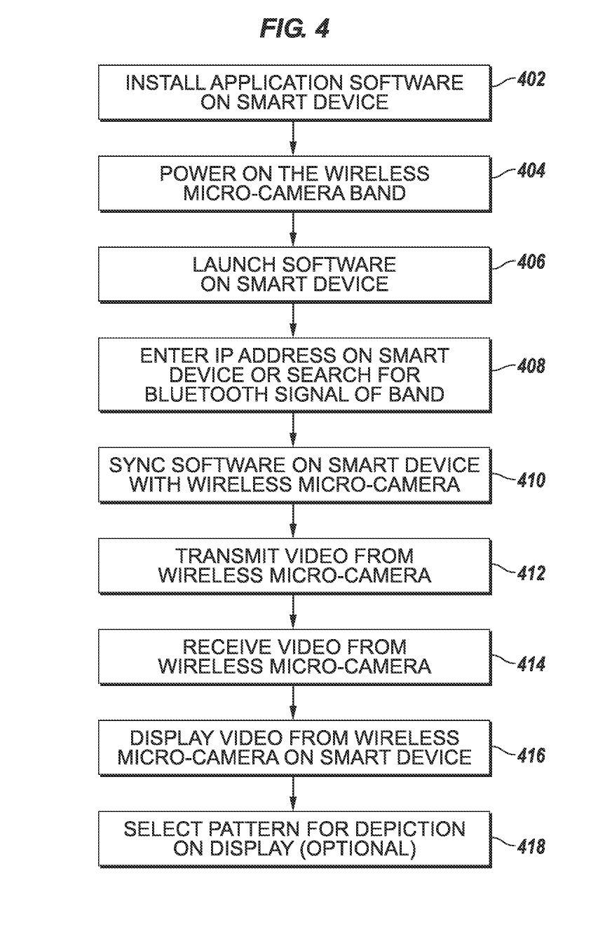

FIG. 4 depicts a flow chart of the software and events for displaying the image of a difficult-to-see location. A user can download and install the application software 402 on their smart device. The power of the wireless micro-camera band can be turned on 404 by pushing the power button on the band. The software on the smart device is subsequently launched 406 and the smart device and wireless micro-camera are located by each other by search or entering an IP address 408. The smart device is synced with the wireless micro-camera 410. Video is transmitted from the wireless micro-camera to the smart device 412. The smart device receives the video 414 and displays it on its screen 416.

FIG. 5 depicts an individual shaving the back of his head 530 while viewing the image of the back of his head on a smart device 526. A wireless micro-camera band is present on the handle 510 of a non-electric razor. The wireless micro-camera 504 is located at one end of the band 502. The wireless micro-camera 504 is powered on and off by pressing power switch 506. A light 516 is located behind the micro-camera 504. The micro-camera 504 obtains the image of the user's head in an approximately 160 degree angle. Therefore an image is transmitted that provides a view of the surroundings of the blade support 518 of the razor on the display 528 of the smart device 526. The user is able to see if any hair 532 is still present on his head 530.

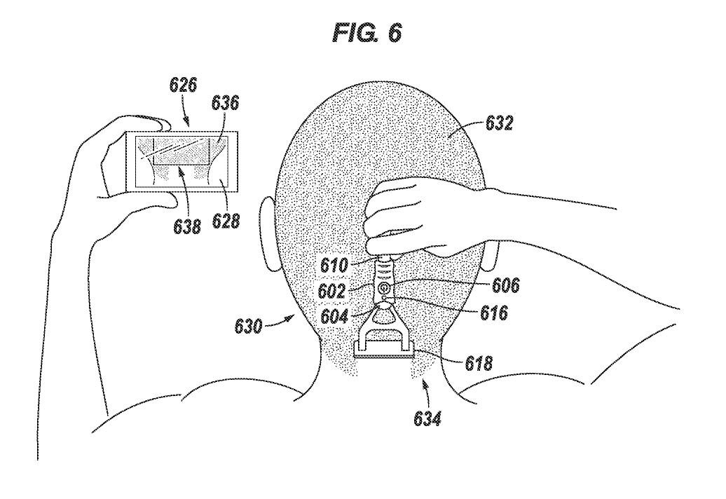

FIG. 6 depicts an individual trimming his hairline 634 while viewing the image of the back of his head on a smart device 626. A wireless micro-camera band is present on the handle 610 of a non-electric razor. The wireless micro-camera 604 is located at one end of the band 602. The wireless micro-camera 604 is powered on and off by pressing power switch 606. A light 616 is located behind the micro-camera 604. The micro-camera 604 obtains the image of the user's head in an approximately 160 degree angle. Therefore an image is transmitted that provides a view of the surroundings of the blade support 618 of the razor on the display 628 of the smart device 626. The display 628 depicts an image of the user's head that is within the approximately 160 degree range of the camera. A hairline outline 638 that was selected by the user is displayed as an overlay of the image of the user. The user is able to see if any hair 632 remains outside of the hairline outline 638.

Various models of camera and orientation of the camera on the device can provide a different angle size capable of being detected by the camera and transmitted to the display. In an embodiment, the angle is 160 degrees. In another embodiment, the angle is 90 degrees. The angle capable of being detected and transmitted can be any angle that provides a view of the area that is desired to be viewed.

In an embodiment, the resolution of the camera is 40 megapixels. In an embodiment, the resolution of the camera is 20 megapixels. In an embodiment, the resolution of the camera is 10 megapixels. In an embodiment, the resolution of the camera is 5 megapixels. In an embodiment, the resolution of the camera can be any resolution that allows the user to see the detail that is needed for the project.

In an embodiment, the band that the camera is on expands and contracts to fit on various instruments. In an embodiment, the band comes in different sizes. In an embodiment, the band comes in different colors.

In an embodiment, the micro-camera band may be stored in a case when not on a tool. In an embodiment, the micro-camera band may be stored in a case with the tool to which it is reversibly attached.

In an embodiment, the micro camera band may be placed on a stand for charging. In an embodiment, the micro-camera band may be charged without using a stand.

In an embodiment, the smart device may be placed on a stand while viewing the display. In an embodiment, the smart device may be reversibly attached to a mechanism that allows the smart device to be attached to a vertical surface, such as a minor or wall. In an embodiment, the mechanism comprises suction cups. In an embodiment, the mechanism comprises screws or adhesive.

In an embodiment, the software application could be downloaded on a website such as a company website, Google Play Store or the Apple App Store. In an embodiment, versions of the software will be available for iPhone, Android, Windows, and Mac. The software can be installed on the smart device, tablet, or laptop.

In an embodiment, the smart device is powered on. The software application is launched on the smart device. Upon opening the software application, an option will be available to enter your IP address or scan for a wireless local area network/Wi-Fi or Bluetooth connection. The smart device and the wireless micro-camera will then be linked and the software with sync with the micro-camera. In an embodiment, a light is present on the band including the micro-camera to indicate that the micro-camera has been successfully linked to their smart device. In an embodiment, the light is a light emitting diode. In an embodiment, the light is a gas-filled bulb. In an embodiment, the light is a xenon bulb. In an embodiment, the light is a halogen light.

In an embodiment, an option can be selected in the software to provide an outline for trimming a hairline. In an embodiment, the outline is superimposed upon the image of the user being shown on the display. In an embodiment, the outline can be resized to match the size of the user's hairline in the image. In an embodiment, the outline has square edges. In an embodiment the outline has rounded edges. In an embodiment, the position of the outline can be locked in place relative to the edges of the head. In an embodiment, an option is available in the software for trimming sideburns. In an embodiment, various patterns of sideburns will be available. In an embodiment, outlines can be downloaded from the internet, websites such as a company website, Google Play Store or the Apple App Store.

In an embodiment, an option can be selected in the software to provide a pattern for shaving a design in the user's hair. In an embodiment, the software has a library of designs to display. In an embodiment, the user can draw or import a design for use in the software. In an embodiment, the design is superimposed as an overlay upon the image of the user being shown on the display. In an embodiment, the design is a line. In an embodiment, the design is a number. In an embodiment, designs can be downloaded from the internet, websites such as a company website, Google Play Store or the Apple App Store. In an embodiment, the can be resized to the preference of the user. In an embodiment, the position of the design can be locked in place relative to the edges of the head.

In an embodiment, the software provides an option to save the files containing the images of the user's head. In an embodiment, the software provides an option to delete the files containing the images of the user's head. In an embodiment, the software allows the designs to be shared via social media. In an embodiment, the software allows the images to be shared via social media.

In an embodiment, the camera can be turned off. In an embodiment, the light can be turned off to save energy. There is a power switch for the camera on the band. In an embodiment, the power button can be pressed a different number of times to turn on the camera, light, or camera and light. In an embodiment, it can have a battery, such as a watch battery. In an embodiment, the battery is an alkaline battery. In an embodiment, the battery is a nickel metal hydride battery. In an embodiment, the battery is rechargeable. In an embodiment, the battery is a lithium battery. In an embodiment, it can be attached to a wireless micro-camera charger or have a charging unit present on the band. In an embodiment, the device can charge through a micro-USB connection 226. In an embodiment, a smart device, tablet, or laptop can be used to charge the wireless micro-camera.

In an embodiment, the band 102 can come in various sizes. In an embodiment, the band 102 can come in various colors. In an embodiment, the wireless micro-camera 104 and band 102 are waterproof. In an embodiment, the wireless micro-camera 104 is fog resistant. In an embodiment, a cover may correspond with the wireless micro-camera to protect the camera lens.

In an embodiment, the band 102 fits snugly on the handle 110. In an embodiment, the band 102 is textured to allow a better grip. In an embodiment, the band has ridges 108 on it to prove an improved grasping surface. In an embodiment, the outer surface of the band 102 is ergonomically-shaped. In an embodiment, the band is placed upon the handle of a razor, wrench, flattening iron, or other tool or grooming tool. In an embodiment, the band 102 can be placed upon a dowel or finger.

In an embodiment, the wireless micro-camera is located in proximity to a light. In an embodiment, the light is a light-emitting diode (LED) light.

In an embodiment, the band includes a transmitter to send the video image to the display device. In an embodiment, the transmitter is a WiFi transmitter. In an embodiment, the transmitter is a Bluetooth transmitter. In an embodiment, the transmitter is a wireless A/V transmitter.

In an embodiment, the band 102 is made from a material selected from the group consisting of silicone, rubber, and polyethylene foam. In an embodiment, the band 102 is comprised of a polymer with elastic properties or elastomer. In an embodiment, the band 102 is waterproof. In an embodiment, the band 102 is made of an antimicrobial material. In an embodiment, the band 102 is comprised of one or more of the substances selected from the group consisting of silicone, polyisoprene, polybutadiene, chloroprene rubber, butyl rubber, styrene-butadiene rubber, nitrile rubber, ethylene propylene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, and thermoplastic elastomers.

The user can use the wireless micro-camera with their current razor. They are not required to purchase a new razor with an integrated camera. If the user chooses to use a different razor, the user merely needs to remove the band from the first razor and slide the band onto the new razor. The user can also use the wireless micro-camera on the band with other instruments for any activities that require the ability to see difficult-to-see areas or an enlarged view. The wireless micro-camera can be used with various tools and instruments including but not limited to razors (non-electric or electric), clippers, tweezers, toothbrushes, flattening irons, curling irons, nose hair trimmers, scissors, knives, screwdrivers, paint brushes, and wrenches.

The wireless micro-camera is useful when using mirrors are not convenient. The device can be used to shave the face when a user does not have a mirror available or prefers not to use one. In an embodiment, the wireless micro-camera can be used when shaving the user's head, face, neck, underarms, legs, bikini area, back, or any location for which the user wishes to view. In an embodiment, the wireless micro-camera can be used when attempting to shave any unwanted body hair.

### EXAMPLES

### Example 1

An individual can obtain a wireless micro-camera band and place it on the handle of his razor with the camera directed toward the end of the razor with the blades. The device would be charged through a micro-USB cable plugged into a computer or wall socket. The individual would download a software application onto his smart device for display of images from the wireless micro-camera. The smart device and camera can link via a wireless connection after the camera and light are turned on and the application is launched. The individual can begin to shave the back of his head while viewing an image of the back of his head on the display of his smart device.

### Example 2

An individual can obtain a wireless micro-camera and place it on the handle of his clippers with the camera directed toward the end of the clippers with the blades. The individual would download a software application onto his smart device for display of images from the wireless micro-camera. The smart device and camera can link via a wireless connection after the camera and light are turned on and the application is launched. A design can be selected from a library in the software application. The individual aligns the design on the displayed image of his head. The individual can resize the design according to his preference and lock the location relative to the edges of head. The individual shaves a design into his hair by following the lines of the design. The design acts as a digital stencil to complete the entire design using clippers.

### Example 3

An individual can obtain a wireless micro-camera band and place it on the handle of a wrench with the camera directed toward the jaws of the wrench. The device would be charged through a micro-USB cable plugged into a computer or wall socket. The individual would download a software application onto his smart device for display of images from the wireless micro-camera. The smart device and camera can link via a wireless connection after the camera and light are turned on and the application is launched. The individual can use the wrench while making plumbing or automotive repairs while viewing an image of the parts to be repaired on the display of his smart device.

### Example 4

An individual can obtain a wireless micro-camera band and place it on the handle of his razor with the camera directed toward the end of the razor with the blades. The device would be charged through a micro-USB cable plugged into a computer or wall socket. The individual would download a software application onto his smart device for display of images from the wireless micro-camera. The smart device and camera can link via a wireless connection after the camera and light are turned on and the application is launched. The individual selects a particular hairline outline from those in the software. The individual can begin to trim his hairline while viewing an image of the portion of his head within the view of his camera overlaid with his selected hairline outline on the display of his smart device.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the methods described herein without departing from the concept, spirit and scope of the invention. More specifically, it will be apparent that certain structures or features which are related may be substituted for the structures or features described herein while the same or similar results would be achieved. All such similar substitutes and modifications apparent to those skilled in the art are deemed to be within the spirit, scope and concept of the invention as defined by the appended claims.

What is claimed is:

1. A device for visualizing an area comprising:
a band capable of being placed on a non-electric tool;
a wireless micro-camera located on the band;
a transmitter located on the band; and
a connection for receiving power located on the band;
wherein the transmitter is capable of transmitting a video signal to a display on a smart device.

2. The device of claim 1 wherein the band is placed on a handle of a non-electric tool.

3. The device of claim 1 wherein the non-electric tool is a razor.

4. The device of claim 1 wherein the display is located on a smart device.

5. The device of claim 4 wherein the smart device comprises an application for viewing the video signal as an image.

6. The device of claim 1 wherein the band is comprised of a flexible material.

7. The device of claim 1 wherein the transmitter is capable of transmitting over a wireless local area network.

8. The device of claim 1 further comprising a light.

9. The device of claim 1 further comprising a USB port.

10. The device of claim 1 further comprising a battery.

11. The device of claim 1 wherein the wireless micro-camera is waterproof.

12. The device of claim 1 wherein the display on the smart device depicts an outline.

13. The device of claim 1 wherein the display on the smart device depicts a pattern.

14. A method of use of a visualization device comprising
placing a visualization device on a non-electric tool; wherein the visualization device comprises
a band capable of being located on a handle of the non-electric tool; and
a wireless micro-camera located on the band; wherein the wireless micro-camera is capable of transmitting a video signal to a display;
turning on the power of a smart device comprising the display;
turning on the power to the visualization device;
sending a video signal from the visualization device to the smart device; and
displaying an image from the visualization device in a software application on the smart device as the video signal is received by the smart device.

15. The method of claim 14 further comprising turning on a light.

16. The method of claim 14 further comprising charging the visualization device prior to use.

17. The method of claim 14 wherein the video signal is sent using a wireless local area network.

18. The method of claim 14 wherein the video signal is sent using Bluetooth.

19. The method of claim 14 wherein the display on the smart device depicts an overlay selected from the group consisting of a pattern and an outline.

20. A system for visualizing an area comprising
a band present on a tool;
a wireless micro-camera located on the band;
a transmitter located on the band, wherein the transmitter is capable of transmitting a video signal to a display on a smart device;
a smart device, capable of receiving a video signal from the transmitter,
a display on the smart device, capable of showing the image resulting from the video signal; and
a supply of power to the wireless micro-camera.
